(19) United States
(12) Patent Application Publication
(10) Pub. No.: US 2013/0071082 A1
(43) Pub. Date: Mar. 21, 2013

(54) HIGH BIREFRINGENCE POLARIZATION-MAINTAINING OPTICAL FIBER BASED ON MULTI COMPONENT SILICA GLASS

(71) Applicants: Eric Gagnon, Quebec (CA); Christophe Lafond, Quebec (CA); Bertrand Morasse, Quebec (CA); Stéphane Chatigny, Quebec (CA)

(72) Inventors: Eric Gagnon, Quebec (CA); Christophe Lafond, Quebec (CA); Bertrand Morasse, Quebec (CA); Stéphane Chatigny, Quebec (CA)

(73) Assignee: CORACTIVE HIGH-TECH INC., Quebec, QC (CA)

(21) Appl. No.: 13/697,509

(22) PCT Filed: May 11, 2011
(86) PCT No.: PCT/CA2011/050291

§ 371 Date: Nov. 12, 2012

Related U.S. Application Data
(60) Provisional application No. 61/334,218, filed on May 13, 2010.

(51) Int. Cl. G02B 6/028; G02B 6/024

(52) U.S. Cl. 385/124

(57) ABSTRACT

The polarization maintaining optical fiber, or preform therefore, can be of the panda type with a pedestal based on a multi-component silica glass doped with a thermal-expansion-coefficient-reducing dopant which can counteracts the thermal-expansion-coefficient-increasing side-effect of the refractive index-increasing dopant, such that when the preform is drilled to make the stress member channel in a heterogeneous region having both a pedestal portion and a cladding portion, the thermal expansion coefficients are sufficiently close to manage damage which could otherwise be caused by uneven thermal expansion caused by drilling heat.

### CROSS-REFERENCE TO RELATED APPLICATIONS/PRIORITY CLAIM

This application claims priority of U.S. provisional application No. 61/334,218, filed May 13, 2010 by applicants, the contents of which are hereby incorporated by reference.

### BACKGROUND

In some applications, polarization variations can induce output beam instabilities. It is thus desired to stabilize the polarization state of the output beam, which has been done using polarization-maintaining optical fibers. Among known types of polarization-maintaining fibers, PANDA optical fibers are widely used and have at least one, and more typically two stress members extending parallel to the core and inducing polarization maintaining asymmetry. PANDA optical fibers can be manufactured as active or passive polarization-maintaining fibers since their manufacturing process allows the separate manufacturing of the stress applying parts, or stress members, and the fiber optic preform with a core left undoped or doped with rare-earth ions for laser or amplifier applications for instance.

Although satisfactory to a certain degree, former polarization-maintaining optical fibers met limitations in terms of the amount of power they could handle.

### SUMMARY

For high-power applications, it is convenient to use multi-clad large-mode-area optical fibers. These fibers have a large rare-earth-doped core. Light delivered by the laser pump diode is injected in the cladding of the optical fiber, which is called the pump-guide, and then coupled into the rare-earth-doped core (i.e. having a rare earth dopant doping the core). The larger surface of large rare-earth-doped core helps managing damage in active optical fibers which can occur given the high injected power of the focused beam. A lower core numerical aperture and coiling of the fiber can then be used to still maintain the possibility to operate the fiber in a single-mode (or more likely quasi-single-mode) core regime.

In order to provide such a low core numerical aperture, a multiple-clad configuration may be used. A first cladding, called the pedestal, is inserted between the rare-earth-doped core and a silica cladding which is called the pump-guide. The main advantage of this design is the possibility to have a highly doped core which can be operated in single mode operation. The core and the pedestal are made of doped silica glasses. To produce polarization maintaining optical fiber having high birefringence capacity, one avenue was to apply a PANDA configuration which such optical fibers.

However, since birefringence levels (which affect the efficiency of the polarization maintenance characteristics) are related to the distance between the stress member and the core, and the diameter of the stress members, and given requirements of pedestal diameter, using the PANDA configuration on such fibers resulted in the stress member(s) to extend partially in the cladding portion and partially in the pedestal to reach satisfactory birefringence levels.

PANDA optical fibers are typically fabricated by the rod-in-tube process, which involves drilling channels in the optical fiber preform, in which the stress members are later inserted. The assembled preform is then drawn into PANDA optical fiber in which the proportions (relative diameters of claddings and position of stress members) of the preform are essentially maintained. During the drilling process, the channel was drilled in a section of silica glass of the preform which had two distinct portions. In the pedestal portion, the silica is typically doped for increasing the refractive index or refraction relative to the cladding portion, which is typically left undoped. Drilling in this heterogeneous section of glass led to occurrences of irreversible damage which made the preform unworkable for drawing effectively into optical fiber.

One possible reason for such damage is that the refractive index-increasing dopants used in the pedestal typically have the side effect of increasing the thermal expansion coefficient of the pedestal material. Since the surrounding cladding is typically left without such dopants, thereby yielding a refractive index step, the surrounding cladding did not suffer from the increase in thermal expansion coefficient and thus had a different thermal expansion coefficient than the pedestal portion. Heat being typically generated during the drilling operation, it is likely that the damage to the preform during drilling was a consequence of uneven thermal expansion of the pedestal and the cladding when subjected to the drilling heat.

A further dopant was added to the pedestal to counter the side effect the refractive index-increasing dopant had on the thermal expansion coefficient, and thereby bringing the thermal expansion coefficient of the pedestal as close as feasible to the thermal expansion coefficient of the cladding while maintaining a satisfactory refractive index step between the cladding and the pedestal. This further dopant is referred to herein as a thermal expansion coefficient-reducing dopant. The tests have shown that this successfully limited the occurrence of damage when drilling a channel in the heterogeneous pedestal/cladding portion.

Henceforth, in accordance with one aspect, there is provided a preform of an optical fiber having a core, a pedestal having both a refractive index-increasing dopant and a thermal expansion coefficient reducing dopant, a cladding around the pedestal, and at least one channel drilled partially in the cladding and partially in the pedestal and housing a stress-member. The thermal expansion coefficient of the pedestal can thus be close to the thermal expansion coefficient of the cladding.

In accordance with another aspect, there is provided a multi-clad polarization-maintaining optical fiber comprising: a core; a pedestal surrounding the core and having a pedestal refractive index, the pedestal being made of silica glass doped both with a refractive index-increasing-dopant having a thermal-expansion-coefficient-increasing side-effect and with a thermal-expansion-coefficient-reducing dopant; a cladding surrounding the pedestal and having a cladding refractive index significantly lower than the pedestal refractive index; at least one a stress member extending parallel to the core into both the pedestal and the cladding and adapted to produce birefringence in the core for polarization-maintaining; an outer cladding having a refractive index significantly lower than the cladding refractive index; and a jacket surrounding the outer cladding.

In accordance with another aspect, there is provided a multi-clad polarization-maintaining optical waveguide comprising: a core with a first refractive index and made with a glass which is doped; a pedestal cladding disposed around said core and having a second refractive index lower than said first refractive index, said pedestal cladding being made of said glass doped at least with a first dopant increasing a refractive index of said glass and increasing a coefficient of thermal expansion of said glass, and a second dopant decreasing said coefficient of thermal expansion of said glass to at least partly cancel said increasing a coefficient of thermal expansion of said glass; a pump-guide cladding disposed around said pedestal cladding and made at least of said glass and having a third refractive index lower than said second refractive index; an outer cladding disposed around said pump-guide and having a fourth refractive index lower than said third refractive index; and at least one stress member extending along said optical waveguide at least partly in said pedestal cladding to produce birefringence in said polarization-maintaining optical fiber.

In accordance with another aspect, there is provided a polarization-maintaining optical waveguide comprising: a core with a first refractive index made with a glass which is doped; a first cladding layer disposed around said core and having a second refractive index lower than said first refractive index, said first cladding layer being made of said glass doped at least with a first dopant increasing a refractive index of said glass and increasing a coefficient of thermal expansion of said glass, and a second dopant decreasing said coefficient of thermal expansion of said glass to at least partly cancel said increasing a coefficient of thermal expansion of said glass; and at least one stress member extending along said optical waveguide at least partly in said first cladding layer to produce birefringence in said polarization-maintaining optical fiber.

In accordance with another aspect, there is provided a method of manufacturing a preform for manufacturing a polarization-maintaining optical fiber from a multi-clad preform having a core region, a pedestal region surrounding the core and having a pedestal refractive index, the pedestal region being of silica glass doped both with a refractive index-increasing-dopant having a thermal-expansion-coefficient-increasing side-effect and with a thermal-expansion-coefficient-reducing dopant at least partially countering thermal-expansion-coefficient-increasing side-effect; and a cladding region surrounding the pedestal and having a cladding refractive index significantly lower than the pedestal refractive index, said method comprising: drilling at least one circular-cross-section channel in a heterogeneous section of the multi-clad preform including both a portion of the pedestal region and a portion of the cladding region.

In accordance with another aspect, there is provided a multi-component silica glass for use in the manufacturing of optical waveguides, the multi-component silica glass comprising: a glass matrix; a first dopant increasing a refractive index of said glass and increasing a coefficient of thermal expansion of said glass matrix; and a second dopant decreasing said coefficient of thermal expansion of said glass to at least partly cancel said increasing a coefficient of thermal expansion of said glass matrix.

Many further features and combinations thereof concerning the present improvements will appear to those skilled in the art following a reading of the instant disclosure.

### DESCRIPTION OF THE FIGURES

In the figures,

FIG. 1 is a schematic illustrating in (a) a configuration, and in (b) a refractive index profile of a multi clad polarization-maintaining optical fiber in accordance with one embodiment;

FIG. 2 is a graph illustrating the effect on thermal expansion of doping silica glass with various dopants;

FIG. 3 is a graph illustrating in (a) the refractive index profile along the x-axis; and in (b) the coefficient of thermal expansion profile of the multi clad polarization-maintaining optical fiber of FIG. 1 along the x-axis;

FIG. 4 is a graph illustrating the coefficient of thermal expansion profile of another embodiment of a multi clad polarization-maintaining optical fiber;

FIG. 5 is a schematic illustrating in (a) a configuration, and in (b) a refractive index profile of a multi clad polarization-maintaining optical fiber in accordance with another embodiment wherein the pedestal has two different layers; and

FIG. 6 is a graph illustrating a refractive index profile of a multi clad fiber-optic preform adapted for the manufacturing of the polarization-maintaining optical fiber of FIG. 1.

It will be noted that throughout the appended drawings, like features are identified by like reference numerals.

### DETAILED DESCRIPTION

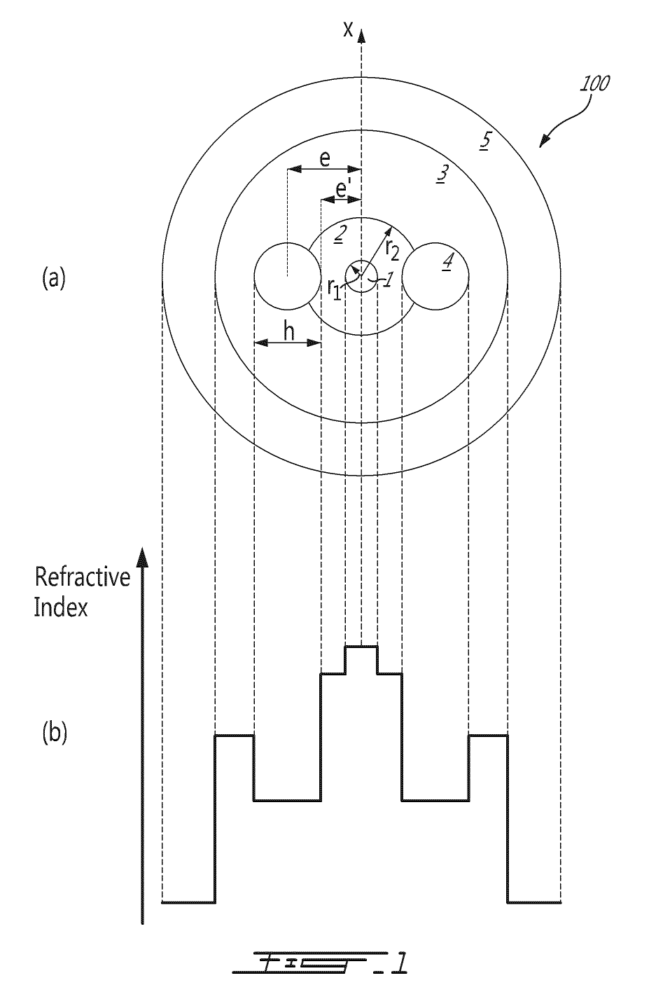

Now referring to the drawings, FIG. 1(a) illustrates a cross-section of a polarization-maintaining optical fiber 100 based on the PANDA configuration, and FIG. 1(b) shows its refractive index profile.

In this example, the optical fiber 100 is an active fiber adapted for continuous high-power power applications. It has a large rare-earth-doped core 1 doped with at least one rare-earth dopant generating laser or amplifier effect; a first cladding, referred to as the pedestal 2, surrounding the large rare-earth-doped core 1; and a second cladding, referred to as the pump-guide 3, surrounding the pedestal. An outer cladding 5 made of glass or polymer with a lower refractive index is also used here. In operation, optical signal power can be propagated in the core 1 while optical pump power is propagated in the pump-guide 3. A PANDA polarization-maintaining configuration is obtained using stress applying parts, referred to as stress members 4 which have a sufficient diameter, and are disposed sufficiently close to the core 1 to produce satisfactory birefringence in the polarization-maintaining optical fiber 100. It will be noted here that in alternate embodiments, the polarization-maintaining optical fiber have only one stress members, or more than two stress members. Further, in some polarization maintaining optical fibers the stress-members have a cross-sectional shape other than circular. Henceforth the typical two circular stress member configuration is shown here only for purpose of providing an example embodiment.

As can be seen from FIG. 1B, the refractive index of the pedestal 2 is slightly lower than that of the core 1 which allows a single-mode or quasi-single-mode propagation of the optical signal in the core 1. The refractive index of the pump-guide 3 is significantly lower than that of the pedestal 2 which can allow doping of the core 1 with a high rare-earth dopant concentration or other specials co-dopants. In order to be efficient, the pedestal 2 should also have a large diameter, i.e. about three to five times larger than that of the core. In fact, it becomes difficult to maintain a single-mode or quasi-single-mode regime in the core 1 when the dopant concentration and/or the core diameter are high. However, by using a large pedestal diameter it is be possible to filter out the higher-order modes by bending to operate the optical fiber, in practice, in a single-mode or quasi-single-mode regime in the core at wavelengths of interest (typically within the 1 μm to 2 μm wavelength range).

The use of a pedestal in rare-earth-doped optical fibers offers many advantages. First, it is known that co-doping with various dopants like aluminum, phosphor, cerium or a mixture thereof can prevent photodarkening in ytterbium-doped optical fibers. Such dopants increase the refractive index of the core. By using a pedestal, a lower numerical aperture of the core can be reached which allows single-mode or quasi-single mode regime.

Second, in the case of erbium-ytterbium co-doped optical fibers, Yb³⁺ ions act as sensitizer ions and Er³⁺ ions as acceptors. Phosphorus oxide P₂O₅ is then added in the core to increase the energy transfer from Yb³⁺ ions to Er³⁺ ions. The pedestal around the core is used to compensate for the refractive index increase due to P₂O₅ doping by reducing the numerical aperture.

Third, such a triple-clad design can make a highly doped single-mode core regime of operation possible.

It is noted that other embodiments can be passive optical fibers which are not doped with rare-earth ions. PANDA triple-clad passive optical fibers may be used as relay fibers for example.

Based on stress analysis of PANDA optical fibers, birefringence B is typically given by the following equation:

$$B = k Δ {α ( \frac{h}{2 e} )}^{2} ( 1 - 3 {( \frac{2 e}{Φ} )}^{4} ) \qquad ( 1 )$$

where k is a characteristic constant of the optical fiber, Δα is the difference in the thermal expansion coefficients of the stress members 4 and the silica cladding 3, h is the diameter of the stress members 4, e is the distance between the center of each stress member 4 and the center of the core 1 and Φ is the diameter of the silica cladding 3.

Equation (1) shows that birefringence increases when the distance e decreases. Accordingly, in order to obtain high birefringence, the stress members 4 should be inserted as close as possible to the core 1.

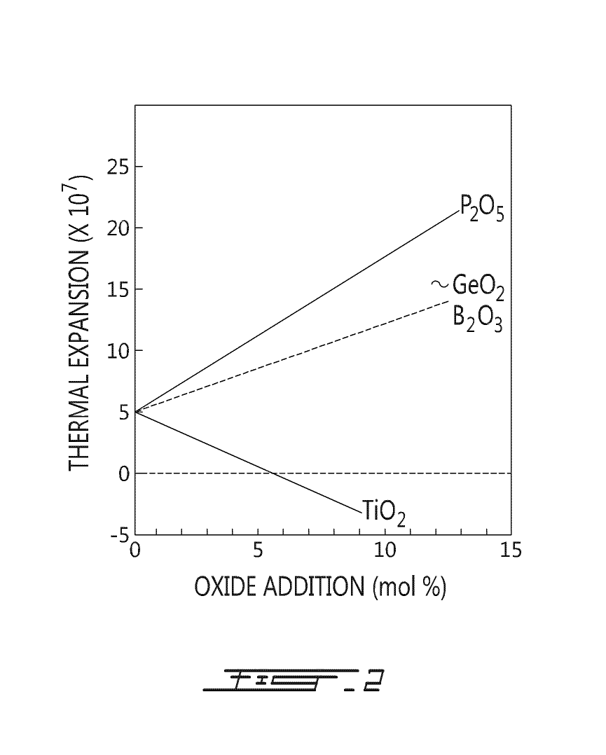

In the case of PANDA fibers, stress members 4 are inserted in the optical fiber 100 at the time of manufacturing the preform which is later used to draw the optical fiber 100. In order to insert the stress members 4, channels are drilled in the preform and stress rods are then inserted in the channels. As mentioned above, the pedestal 2 should have a diameter of about three to five times larger than the diameter of the core 1. Accordingly, for the stress member 4 to be large enough and close enough to the core 1 to obtain high birefringence, the preform is drilled partly in the pedestal 2, and partly in the cladding 3. However, the refractive index of the pedestal 2 should be selected to obtain a high numerical aperture between the pedestal 2 and the pump-guide silica cladding 3. The targeted refractive index is typically reached in the pedestal 2 by adding germanium oxide GeO₂, or another refractive index-increasing dopant, in the glass composition, which increases the refractive index but also has the side-effect of increasing the thermal expansion coefficient of the silica glass. As shown in FIG. 2, GeO₂ creates a thermal expansion coefficient increase of about 0.7×10⁻⁷/° C. per mol %. Such an increased thermal expansion coefficient can create stresses in the preform when subjected to drilling heat and cause irreversible damages.

It is therefore proposed herein to modify the composition of the pedestal 2 to decrease the thermal expansion coefficient of the pedestal 2 in order to reduce this stress and allow safe drilling of the preform as close as possible to the core 1. This is done by co-doping the silica glass of the pedestal 2 with titanium oxide (TiO₂), or another thermal-expansion-coefficient-reducing dopant, which may also have an effect on the refractive index but decreases the thermal expansion coefficient of the silica glass, thereby at least partly canceling the thermal expansion coefficient increase due to other co-dopants like GeO₂. Henceforth, a ratio of refractive index-increasing dopant(s) and thermal-expansion-coefficient-reducing dopant(s) can be selected to achieve satisfactory refractive index while yielding a thermal expansion coefficient equal to, or at least operatively close to the surrounding cladding. The expression operatively close to, in this context, means close enough to maintain damages caused by thermal expansion during drilling under an acceptable threshold given the intended application.

FIG. 2 shows the thermal expansion coefficient of silica glass with varied concentrations of dopants (doping compounds) including P₂O₅, GeO₂, B₂O₃ and TiO₂ as given in Izawa et al., “Optical fibers: Materials and Fabrication” p. 48, Eds. KTK Scientific Publishers, Tokyo (1987)”. According to Izawa et al., a doping of 1 mol % of TiO₂ induces a decrease of 0.9×10⁻⁷/° C. of the thermal expansion coefficient of silica glass. TiO₂ also increases the refractive index in silica glass by 4.3×10⁻³ per mol % of TiO₂. Due to its properties on the refractive index and the thermal expansion coefficient, TiO₂ is a good candidate as a co-dopant in the composition of the pedestal 2.

Back to FIG. 1, the composition of one example of a polarization-maintaining optical fiber 100 is as follows. The optical fiber 100 is made of silica glass. The core 1 is either doped with one or more rare-earth element in the case of an active optical fiber 100 or with a refractive index increasing dopant such as GeO₂ in the case of a passive optical fiber 100. The core 1 has a diameter Φ₁ typically larger than or equal to 10 μm. The pedestal 2 is co-doped with GeO₂ which increases the refractive index and increases the thermal expansion coefficient of silica glass, and TiO₂ which decreases the thermal expansion coefficient of silica glass such that the thermal expansion coefficient decrease due to TiO₂ satisfactorily cancels the thermal expansion coefficient increase due to GeO₂. The GeO₂ and TiO₂ concentrations are selected to achieve the targeted refractive index and thermal expansion coefficient for the pedestal 2. The pedestal 2 has a diameter Φ₂ such that Φ₂/Φ₁>3. Such a large ratio between the diameter Φ₂ of the pedestal 2 and the diameter Φ₁ of the core provides a single-mode or quasi-single-mode regime in the core 1. The pump-guide cladding 3 is made of undoped silica glass and has a diameter Φ₃. The third cladding 5 is made of a low refractive index polymer such as fluoroacrylate polymer coating, Teflon™ coating, or silicone coating, or with a silica glass doped to reduce the refractive index such as fluorine-doped silica glass for example. The numerical aperture between the third cladding 5 and the pump-guide cladding 3 should be as high as possible to ensure an optimum confinement of the pump light in the pump-guide cladding 3.

As shown in FIG. 1, the refractive index of the core 1 is the highest. The refractive index of the pedestal 2 is lower than the refractive index of the core 2 and higher than the refractive index of the pump-guide cladding 3. The third cladding 5 has a refractive index lower than the refractive index of the pump-guide cladding 3. In one particular case, the numerical aperture between the core 1 and the pedestal 2 is in the range of about 0.06 to 0.08 and the numerical aperture between the pedestal 2 and the pump-guide cladding 3 is in the range of about 0.12 to 0.20.

Equation (1) shows that birefringence is proportional to the thermal expansion coefficient difference Δα between stress members 4 and the pump-guide silica cladding 3.

Accordingly, one factor in obtaining satisfactorily high birefringence is using a high thermal expansion coefficient in the stress members 4. Stress members 4 are typically made of silica glass doped with phosphorus oxide (P₂O₅) and boron oxide (B₂O₃) or with boron oxide only. Boron oxide increases the thermal expansion coefficient of silica glass and it also significantly reduces its refractive index. In fact, birefringence increases linearly with the increase of the boron doping level. Also, as mentioned above, in order to obtain high birefringence, the stress members 4 should be disposed as close as possible to the core 1 and be sufficiently large. Accordingly, the stress members 4 typically overlap the pedestal 2. More specifically, the distance e′ between the centre of the optical fiber 100 and the nearest edge of the stress members 4 is somewhere between the radius r₁ of the core 1 and the radius r₂ of the pedestal 2.

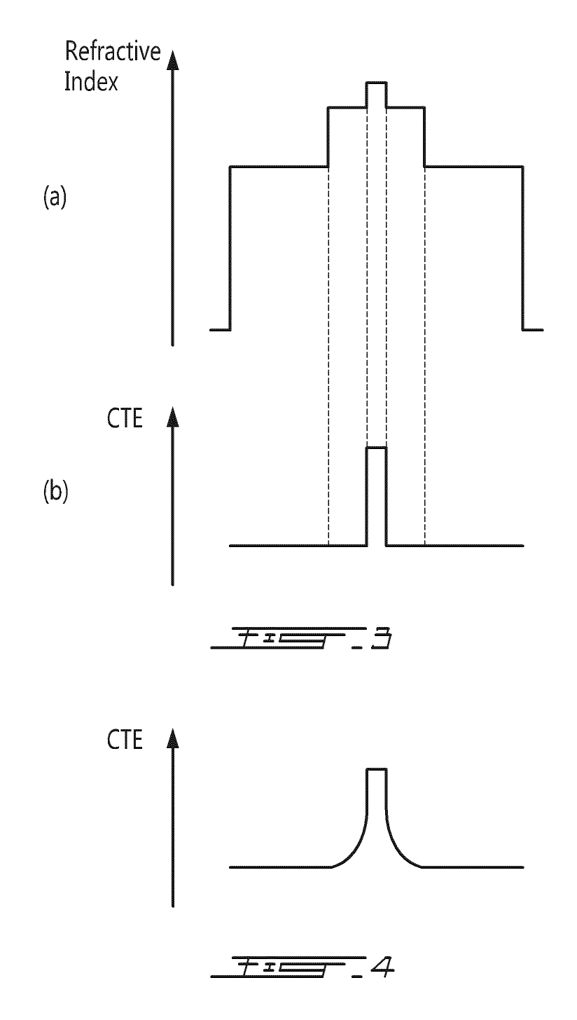

FIG. 3 shows the refractive index profile and the thermal expansion coefficient profile of the optical fiber 100 of FIG. 1 along the x-axis. In this embodiment, the concentrations of GeO₂ and TiO₂ in the pedestal 2 are adjusted such that the thermal expansion coefficient of the pedestal 2 is lower than the thermal expansion coefficient of the core 1 and substantially equal to the thermal expansion coefficient of the pump-guide cladding 3. In another embodiment (not illustrated), the concentrations of GeO₂ and TiO₂ in the pedestal 2 can be adjusted such that the thermal expansion coefficient of the pedestal 2 is lower than the thermal expansion coefficient of the core 1 and only slightly higher than the thermal expansion coefficient of the pump-guide cladding 3, while staying operatively close to it.

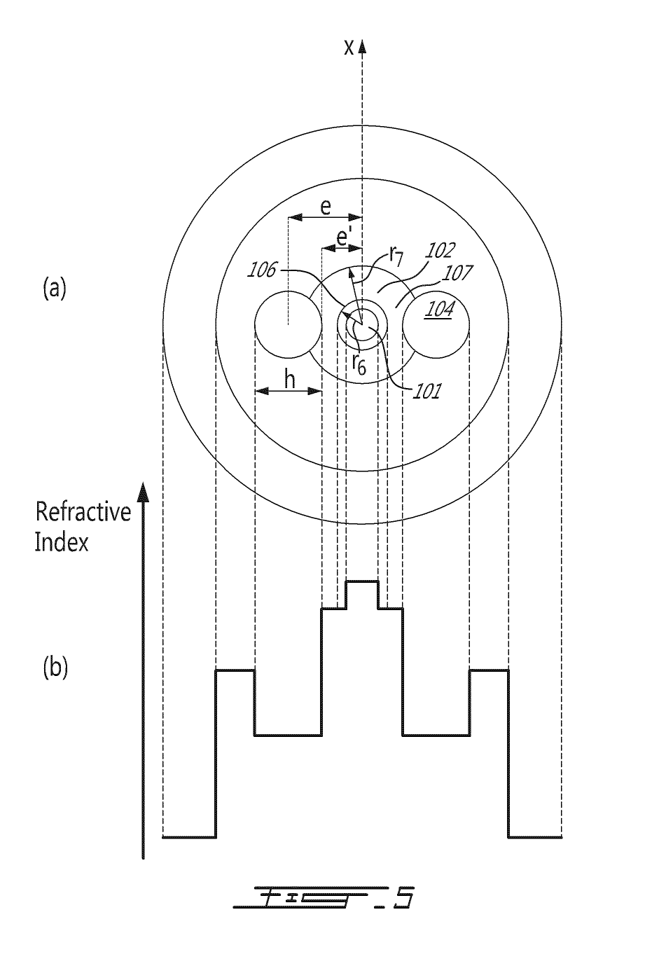

FIG. 4 shows the thermal expansion coefficient profile of a triple-clad polarization-maintaining optical fiber in accordance with still another embodiment where the refractive index profile is the same as the one shown in FIG. 3(a) but where the concentrations of GeO₂ and TiO₂ in the pedestal 2 vary as a function of the radius of the optical fiber such that the thermal expansion coefficient smoothly decreases from radius r₁ of the core 1 to radius r₂ of the pedestal 2.

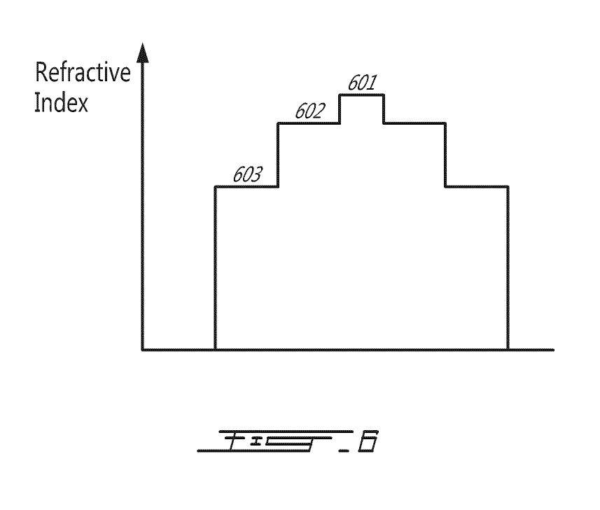

FIG. 5 illustrates another embodiment of a multi-clad polarization-maintaining optical fiber where the pedestal 102 is only partially doped with titanium. The pedestal is made of two concentric layers, i.e. an inner layer 106 and an outer layer 107, the two having the same refractive index. The inner layer 106 is disposed around the core 101 and is doped to increase the refractive index, in this case with GeO₂. The outer layer 107 is disposed around the inner layer 106 and is co-doped with TiO₂ and GeO₂. GeO₂ increases both the refractive index and the thermal expansion coefficient while TiO₂ increases the refractive index but decreases the thermal expansion coefficient. This configuration finds applications in fibre lasers where the output power decreases when the attenuation at the emission wavelength increases. In the configuration of FIG. 1, the incorporation of TiO₂ in the pedestal 2 which is close to the core 1 may cause an increase of the attenuation at the emission wavelength. The construction of the pedestal in two layers 106, 107 with the inner layer 106 having no TiO₂ helps preventing this. The inner layer 106 acts as a buffer between the core 101 and the TiO₂ co-doped outer layer 107. For the PANDA design, the stress members 104 are positioned such that the distance e′ between the centre of the optical fiber and the nearest edge of the stress members 104 is somewhere between the radius r₆ of the inner layer 106 and the radius r₇ of the outer layer 107. The stress members 104 therefore only overlap the outer layer 107.

An example of a process that can be used to manufacture a polarization-maintaining optical fiber based on the configuration described above is now discussed. The process is now described for the particular example of the triple-clad polarization-maintaining optical fiber 100 as shown in FIG. 1 but it is noted that a similar processes may be used to produce other embodiments of optical fiber. The following process can be adapted to either both passive or active optical fibers. The main steps of manufacturing are: 1) manufacturing a precursor preform, 2) drilling channels in the precursor preform, 3) polishing the inner surfaces of the channels, 4) manufacturing the stress members, 5) inserting the stress members in the channels, and 6) drawing the preform into an optical fiber.

1) Manufacturing a Precursor Perform

FIG. 6 illustrates the refractive index profile of a fiber-optic preform used as a precursor to manufacture a triple-clad polarization-maintaining optical fiber. The precursor preform is made using the Modified Chemical Vapor Deposition (MCVD) as known in the art. A low-OH fused silica tube which provides the pump-guide cladding region 603 is used.

The pedestal region 602 is fabricated inside the low-OH fused silica tube. Successive layers of the glass composition SiO₂—GeO₂—TiO₂ are deposited inside the low-OH fused silica tube by heating with a H₂/O₂ burner a mixture of SiCl₄, GeCl₄ and TiCl₄ precursors. The number of layers and the flow of the precursors are selected to satisfy the desired ratio between the pedestal diameter (Φ₂) and core diameter (Φ₁), such as Φ₂/Φ₁>3.

It is noted that according to Paul et al. in “Chemistry of titanium incorporation in silica glass of optical preform for making of Ti doped optical fibre by the MCVD process”, Optical Materials, 30, pp 1538-1548 (2008) which studies the kinetic of TiO₂ incorporation in silica glass using the MCVD process with TiCl₄ as the gaseous precursor, the deposition temperature has a less than significant effect on the titanium concentration. However, it is preferable to deposit TiO₂ at low temperature to avoid the parasite reduction of Ti(IV) in Ti(III) since this reaction induces a brown coloration of the glass which increases the attenuation. Paul et al. also recommend that TiO₂ concentration should not be larger than 2 mol % because too high concentration gives rise to brown coloration.

Next, the core region 601 of the preform is fabricated. In the case of an active optical fiber, porous silica soot layers with or without various refractive index raising co-dopants like germanium oxide and/or phosphorus oxide are deposited inside the tube. Rare-earth elements are then doped inside the porous layers by the solution doping process, as known in the art. Rare-earth elements may include thulium (Tm), erbium (Er), ytterbium (Yb), etc., and a mixture thereof. The solution is made with rare-earth salts precursors. Al₂O₃ or P₂O₅ are known to increase the solubility of the rare-earth elements inside the silica glass network. Aluminum salt and/or orthophosphoric acid (H₃PO₄) are therefore also added to the solution. After drying, the rare-earth doped silica soot layers are sintered at high temperature. The tube is then collapsed by increasing the temperature of the burner.

In the case of a passive optical fiber, successive glass layers of silica doped with raising refractive index dopants like GeO₂ and/or P₂O₅ are deposited inside the tube 603 by heating with a H₂/O₂ burner a mixture of precursors like SiCl₄, GeCl₄ and/or POCl₃. The tube is then collapsed by increasing the temperature of the burner.

The precursor preform is then etched with hydrofluoric acid or overclad with a low-OH fused silica tube to get the right ratio diameter between the pump-guide cladding region 603 and the core region 601.

2) Drilling Channels in the Precursor Perform

A section of the precursor preform is then cut for the drilling step. Using an ultra-sonic milling machine, two channels are drilled. The key drilling parameters are the diameter h of the holes and the position of the holes. In fact, equation (1) shows that stress member diameter h and the distance e between the center of the stress members and the center of the optical fiber have a great influence on the birefringence. A large stress member diameter h and a short distance e are required to obtain high birefringence. The addition of titanium oxide in the pedestal allows drilling the precursor preform quite close to the core in order to obtain a low distance e between the center of the stress members and the center to the optical fiber such that the distance e′ between the centre of the optical fiber and the nearest edge of the stress member satisfies the condition: r₁<e′<r₂.

3) Polishing the Inner Surfaces of the Stress Member Channels

The inner surface of the stress member channels is then polished with a low intensity H₂/O₂ flame to avoid deformation of the holes.

4) Manufacturing the Stress Members

The stress members are fabricated separately, such as with the MCVD process. Equation (1) shows that birefringence is proportional to the coefficient of thermal expansion difference between stress members and pump-guide cladding noted Δα. Accordingly, stress members are typically made of silica glass which is doped to increase its thermal expansion coefficient in order to obtain high birefringence. The stress members are typically made using silica glass doped with P₂O₅ and B₂O₃ or with B₂O₃ only. The stress members are then drawn into smaller diameter rods to fit in the drilled stress member channels.

5) Inserting the Stress Members in the Channels

The stress members are then inserted into the channels in the preform. That assembled preform is then drawn into PANDA optical fiber.

6) Drawing the Preform into an Optical Fiber

In the case of triple-clad polarization-maintaining optical fiber designed for high power applications, an outer cladding made of a low refractive index polymer such as fluoroacrylate polymer coating, Teflon™ coating, or silicone coating is typically added around the optical fiber in the drawing process. The low refractive index cladding may also consist of a specialty silica glass doped with fluorine, for example, and which is deposited around the preform before drilling. An air-clad cladding may also be used to provide a low refractive index cladding by assembling one or more rings of silica capillaries around the preform and overcladding it with a silica tube. In any case, a protective polymer coating is finally added. The final diameter of the triple-clad polarization-maintaining optical fiber is selected as a function of the application for which it is designed.

### Example

### Triple-Clad Panda Passive Optical Fiber

A preform was fabricated by the MCVD process. First, the multi-component pedestal GeO₂—TiO₂ doped silica glass was deposed on a low-OH fused silica tube. GeO₂ and TiO₂ concentrations were targeted to get a difference of thermal expansion coefficient between the pedestal and the silica cladding operatively close to zero. The GeO₂ doped silica core was then deposed. φ₂ and φ₁ are respectively the pedestal and the core diameters. Core and pedestal layers were optimised such as φ₂/φ₁ larger than 3. The preform was then sintered.

After the preform fabrication, two channels were drilled in a 200 mm long section of the preform by using an ultra-sonic milling machine. The PANDA geometry was designed for a 125 microns diameter optical fiber such as:
Stress member diameter=30 microns
Distance e′=15 microns.

No cracking of the preform was observed during the drilling. After drilling, both channels were fire-polished and B₂O₃ doped silica stress members were inserted into the channels.

This assembled preform was then drawn into a 125 microns optical fiber. A UV cured low refractive index fluoroacrylate polymer is deposed as the outer cladding and the optical fiber is protected by a UV cured standard acrylate polymer.

The obtained triple-clad PANDA optical fiber had the following specifications:
Pedestal GeO₂ concentration=1.4 mol %
Pedestal TiO₂ concentration=1.2 mol %
Core GeO₂ concentration=8 mol %
Stress member B₂O₃ concentration=20 mol %
Core diameter φ₁=10 microns
Pedestal diameter φ₂=42 microns
Stress member diameter h=27 microns
Distance e′=15 microns
Core NA=0.09
Pedestal NA=0.13
Pump-guide NA=0.46
Birefringence B=2.3×10⁻⁴

The measured GeO₂ and TiO₂ concentrations and their contributions to the silica glass thermal expansion coefficient were used to calculate the difference in thermal expansion coefficient between the pedestal and the silica cladding. We get 0.1×10⁻⁷/° C. As targeted, this value is close to zero and resulted in drilling of the preform being done without noticeable damage. It is further noted that the core and pedestal diameters satisfy the condition φ₂/φ₁>3, and the distance e′ satisfies the condition r₁<e′<r₂.

Although the test was made on a passive fiber, we soundly predict that this would also work in the case of some active fibers. Given the theory that the disappearance of irreversible damage is caused by the use of the thermal expansion coefficient-reducing dopant in the pedestal which brings the thermal expansion coefficient operatively close to the thermal expansion coefficient of the surrounding cladding, it is believed that adding a lasing-effect or other dopant to the core should not have any significant effect when drilling the channels, since the drilling is effected in the cladding and the pedestal.

It is noted that titanium oxide is used in the above described embodiments because of a combination of its optical and mechanical properties in silica glass. One will understand that other dopant(s) having counteracting effects on the thermal expansion coefficient, such as niobium or tantalum (Nb₂O₅, Ta₂O₅) for instance, may be used instead.

Depending on the specific application, the values of birefringence reached can vary between 2×10⁻⁴ and 5×10⁻⁴, for instance.

As can be seen therefore, the examples described above and illustrated are intended to be exemplary only. The scope is indicated by the appended claims.

1. A multi-clad polarization-maintaining optical fiber comprising
a core having a core refractive index;
a pedestal surrounding the core and having a pedestal refractive index lower than the core refractive index, the pedestal having a layer of silica glass doped both with a refractive index-increasing-dopant having a thermal-expansion-coefficient-increasing side-effect and with a thermal-expansion-coefficient-reducing dopant;
a cladding surrounding the pedestal and having a cladding refractive index significantly lower than the pedestal refractive index;
at least one stress member extending parallel to the core into both the pedestal and the cladding and adapted to produce birefringence in the core for polarization-maintaining;
an outer cladding having an outer cladding refractive index significantly lower than the cladding refractive index; and
a jacket surrounding the outer cladding.

2. The polarization-maintaining optical fiber of claim 1 wherein the thermal expansion coefficient of the pedestal and the thermal expansion coefficient of the cladding are one of equal and operatively close in value.

3. The polarization-maintaining optical fiber of claim 1 wherein the refractive index-increasing-dopant is one of GeO₂, P₂O₅.

4. The polarization-maintaining optical fiber of claim 1 wherein thermal-expansion-coefficient-reducing dopant is one of TiO₂, Nb₂O₅, Ta₂O₅.

5. The polarization-maintaining optical fiber of claim 1 wherein the cladding is made of undoped silica glass.

6. The polarization-maintaining optical fiber of claim 1 wherein the at least one stress member has a circular cross-section.

7. The polarization-maintaining optical fiber of claim 1 wherein the core is doped with at least one rare-earth ion for laser or amplifier applications.

8. The polarization-maintaining optical fiber of claim 1, wherein the core is operable in single-mode or quasi-single-mode regime at wavelengths between 1 μm and 2 μm.

9. The polarization-maintaining optical fiber of claim 1 being a passive optical fiber wherein the core is of silica glass doped only with a refractive index-increasing dopant.

10. The polarization-maintaining optical fiber of claim 1 wherein the birefringence is of between 2×10⁻⁴ and 5×10⁻⁴.

11-19. (canceled)

20. A fiber-optic preform for manufacturing a polarization maintaining optical fiber, the preform comprising:
a core region having a core refractive index;
a pedestal region surrounding the core and having a pedestal refractive index lower than the core refractive index, the pedestal region having a layer of silica glass doped both with a refractive index-increasing-dopant having a thermal-expansion-coefficient-increasing side-effect and with a thermal-expansion-coefficient-reducing dopant at least partially countering the thermal-expansion-coefficient-increasing side-effect; and
a cladding region surrounding the pedestal region and having a cladding refractive index significantly lower than the pedestal refractive index
at least one a stress member extending parallel to the core into both the pedestal region and the cladding region and adapted to produce birefringence in the core for polarization-maintaining.

21.-29. (canceled)

30. The polarization-maintaining optical fiber of claim 1 wherein the pedestal further includes an inner layer surrounded by said layer of silica glass doped with both dopants, said inner layer being made of silica glass doped solely with a refractive index-increasing dopant.

31. The fiber-optic preform of claim 20 wherein the pedestal further includes an inner layer surrounded by said layer of silica glass doped with both dopants, said inner layer being made of silica glass doped solely with a refractive index-increasing dopant.

32. The polarization-maintaining optical fiber of claim 20 wherein the thermal expansion coefficient of the pedestal and the thermal expansion coefficient of the cladding are one of equal and operatively close in value.

33. The polarization-maintaining optical fiber of claim 20 wherein the refractive index-increasing-dopant is one of GeO₂, P₂O₅.

34. The polarization-maintaining optical fiber of claim 20 wherein thermal-expansion-coefficient-reducing dopant is one of TiO₂, Nb₂O₅, Ta₂O₅.

35. The polarization-maintaining optical fiber of claim 20 wherein the cladding is made of undoped silica glass.

36. The polarization-maintaining optical fiber of claim 20 wherein the at least one stress member has a circular cross-section.

37. The polarization-maintaining optical fiber of claim 20 wherein the core is doped with at least one rare-earth ion for laser or amplifier applications.

38. The polarization-maintaining optical fiber of claim 20 being a passive optical fiber wherein the core is of silica glass doped only with a refractive index-increasing dopant.
